(19) United States
(12) Patent Application Publication
(10) Pub. No.: US 2026/0369190 A1
(43) Pub. Date: Nov. 19, 2026

(54) Dynamic 3D Holographic Display System Using Water Vapor for Retail Marketing

(71) Applicant: Wai Hung Ng, Hong Kong (HK)

(72) Inventor: Wai Hung Ng, Hong Kong (HK)

(21) Appl. No.: 19/206,117

(22) Filed: May 13, 2025

(51) Int. Cl. G09F 19/18; G01P 13/00

(52) U.S. Cl. CPC G09F 19/18; G01P 13/0006

(57) ABSTRACT

The present invention provides a dynamic display system designed for retail marketing, utilizing advanced water vapor and projection technology to create engaging 3D holographic images. The system includes a display stand housing essential components such as a water tank, an expansion chamber, an airbox, and a power supply unit. The water tank stores water that is vaporized in the expansion chamber, forming a stable medium for 3D projections. A specialized nozzle emits a sheet of water vapor, onto which a high-resolution 3D image is projected by an integrated projector with advanced optics. The system features environmental sensors and a comprehensive monitoring system, including an anemometer to detect windy conditions. The control unit dynamically adjusts vapor production and stops it when excessive wind speeds are detected, ensuring stability and safety. This offers a visually appealing solution for attracting potential customers to retail storefronts, addressing the limitations of traditional marketing methods.

### FIELD OF INVENTION

The present invention relates to dynamic display systems for retail marketing, specifically to a system that utilizes water vapor and projection technology to create engaging 3D holographic images.

### BACKGROUND OF THE INVENTION

Attracting the attention of passersby is a common challenge for businesses. Traditional methods such as inflatable decorations or balloon displays are popular but come with significant drawbacks. Inflatable decorations can be unstable, posing a hazard in strong winds, and balloons can easily fall over or deflate, losing their effectiveness and potentially causing safety issues.

A newer, more innovative approach to capturing the attention of potential customers involves using advanced vapor barriers. These barriers are designed to be installed in front of stores or curbside, creating a captivating display that directs foot traffic towards the business. Unlike inflatables, these barriers are stable and resilient against adverse weather conditions, such as strong winds, ensuring they remain effective and safe.

Vapor barriers utilizing water vapor and projection technology provide a dynamic and engaging way to attract attention. The system generates water vapor to create a stable medium for projecting 3D holographic images. This approach not only avoids the pitfalls associated with inflatable decorations but also offers a unique and modern aesthetic that can enhance the visual appeal of a storefront.

The benefits of these water vapor-based vapor barriers are multifaceted. Firstly, the water vapor medium is stable and does not fall over in strong winds, unlike inflatable decorations. The system is designed to withstand various environmental conditions, ensuring continuous operation without posing hazards. Secondly, the advanced projection technology allows for the creation of captivating 3D holographic displays that are more likely to draw attention compared to static or traditional decorations. The dynamic nature of the display can be used to showcase promotions, advertisements, or brand messages in an eye-catching manner. Thirdly, the vapor barrier system is easy to set up and operate, making it convenient for business owners to deploy. The system can be controlled remotely, allowing for quick adjustments and updates to the displayed content. Lastly, the system incorporates sensors and adaptive controls to maintain optimal performance in varying environmental conditions. Real-time adjustments ensure that the display remains clear and effective regardless of changes in wind speed, humidity, or temperature.

In the past, attempts have been made to use conventional temporary structures, such as inflatable decorations or balloon displays, to attract attention and direct foot traffic to stores. However, these methods pose safety hazards due to their instability in windy conditions and the potential for materials to fall over or deflate, creating obstructions or losing their intended effect. Additionally, quickly and efficiently building a vapor barrier using traditional materials can be challenging, often requiring significant effort and maintenance to remain effective and safe.

Therefore, there is a need for vapor barriers that are easy to place and assemble in front of stores or curbside, providing a stable and engaging display that does not pose safety hazards when used outdoors in windy conditions. The present invention addresses this need by providing a system that generates water vapor to create a stable medium for 3D holographic projection, offering a significant improvement over traditional inflatable or balloon-based decorations. This innovative approach ensures that businesses can capture the attention of passersby effectively and safely, even in challenging weather conditions.

### SUMMARY OF THE INVENTION

The present invention provides a dynamic display system designed to attract attention to retail storefronts using advanced water vapor and projection technology. The system comprises a display stand that houses essential components, including a water tank, an expansion chamber, an airbox, and a power supply unit. The water tank stores water that is vaporized in the expansion chamber to create a stable medium for 3D holographic projections.

A specialized nozzle emits a sheet of water vapor, and a projector integrated with advanced optics projects high-resolution 3D images onto this vapor medium. The display stand is designed for easy transport and assembly, making it convenient for deployment in front of stores or curbsides.

The system incorporates environmental sensors and adaptive control systems that dynamically adjust vapor production and projection parameters based on real-time data. This ensures optimal performance under varying environmental conditions, such as changes in wind speed, humidity, and temperature.

The water vapor medium is maintained at a uniform density and distribution through precise control mechanisms, and the use of laminar flow chambers stabilizes the vapor for a clear and effective projection surface. Additional features include air curtains and baffles to manage the vapor volume, as well as a comprehensive environmental monitoring system that provides continuous feedback for real-time optimization.

This innovative approach addresses the shortcomings of traditional marketing methods by offering a stable, engaging, and modern solution for capturing the interest of potential customers, even in challenging weather conditions.

### BRIEF DESCRIPTION OF DRAWINGS

FIG. 1A is a plain view of an arrayed vapor barrier from a top.

FIG. 1B is a plain view of an arrayed vapor barrier from a projection side.

FIG. 1C is a plain view of an arrayed vapor barrier from an projection side.

FIG. 2 is a block diagram demonstrating 3D holographic projections, consistent with an embodiment of the present invention.

FIG. 3A is a cutaway view showing an electronic control system and isolated views of a water level sensor within the water container according to the present invention.

FIG. 3B is an illustration of an alternative embodiment of the water container according to the present invention.

FIGS. 3C-D FIG. 3C and FIG. 3D show views of a gang-able nozzle design, according to an embodiment of the invention.

FIGS. 4A-B FIG. 4A and FIG. 4B show views of a airbox, according to an embodiment of the invention.

### DETAILED DESCRIPTION OF THE INVENTION

A long-standing challenge in retail marketing is to capture the attention of passersby effectively. Traditional methods such as inflatable decorations or balloon displays often fail to address this challenge due to their instability and safety hazards in adverse weather conditions. The present invention provides a dynamic display system for retail storefronts that utilizes water vapor and projection technology to create engaging 3D holographic images, attracting potential customers in a safe and visually appealing manner.

The vapor barrier system is designed to be installed in front of stores or curbside, creating a captivating display that directs foot traffic towards the business. The system includes a display stand that houses the necessary components for generating and projecting the vapor barrier. The stand is designed for easy transport and assembly, ensuring quick deployment and stability in various environmental conditions.

The display stand includes a water tank for holding water, an expansion chamber for creating vapor, an airbox for creating a laminar flow of air and vapor, and a power supply unit. The water tank is equipped with a detection circuit and a control unit to monitor and maintain optimal water levels. The expansion chamber vaporizes the water, which is then pressurized and pushed through the airbox to create a stable vapor medium.

An anemometer is included to detect windy conditions. This anemometer provides real-time data to the control unit, enabling it to dynamically adjust the system's operation. When the anemometer detects wind speeds exceeding a predetermined threshold, the control unit stops vapor production to prevent instability and ensure safety.

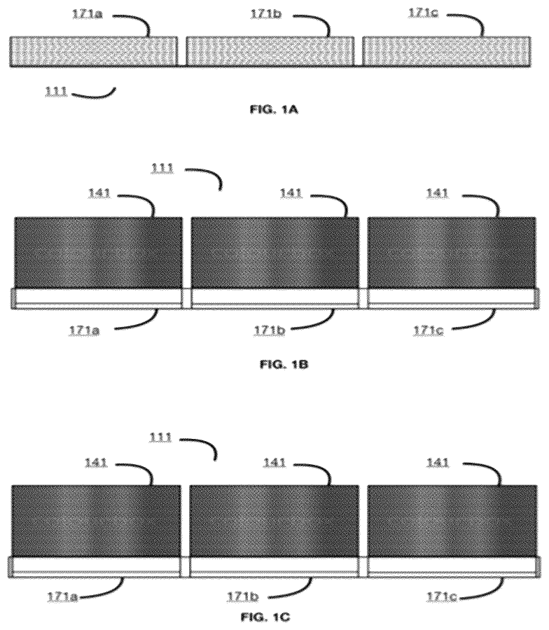

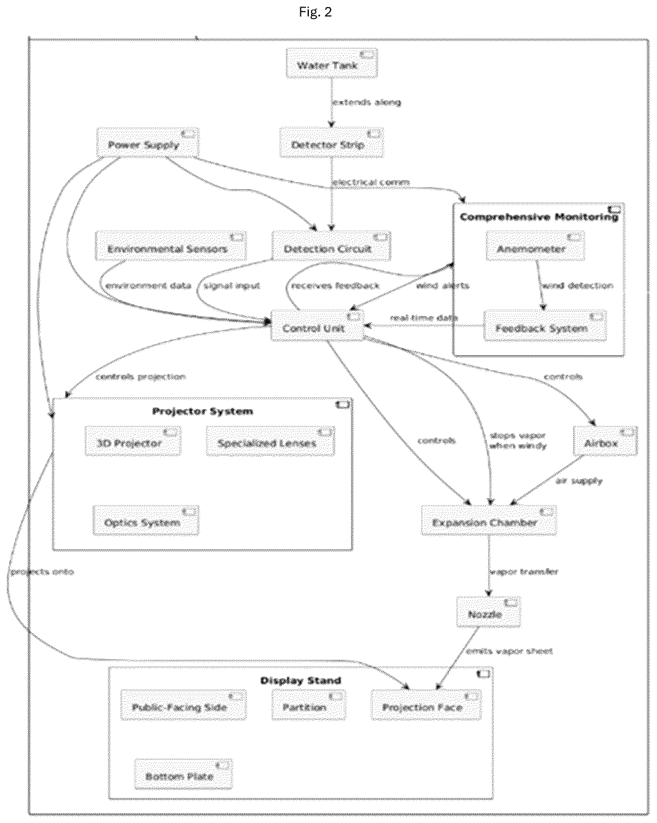

An array of vapor barriers, shown from above in FIG. 1A, from the projection side in FIG. 1B, and from the public-facing side in FIG. 1C, includes a system of display stands placed end to end. Each display stand is equipped with overlapping structures to ensure secure placement and alignment, even on uneven surfaces. The vapor barriers are designed to withstand strong winds and adverse weather conditions, ensuring continuous operation without posing hazards.

The display stand is representative of the display stands used in the arrayed vapor barrier. Each stand is mobile for easy transport and assembly. The stands are tightly abutted to each other, creating an instant barrier that is both stable and visually engaging.

The airbox, housed within the display stand, is responsible for creating a laminar flow of air and vapor. The airbox includes a series of mesh and honeycomb panels that even out air turbulence and pressure, resulting in a stable and uniform vapor medium. The nozzle emits the vapor in a flat and straight form, providing an optimal surface for projecting 3D holographic images.

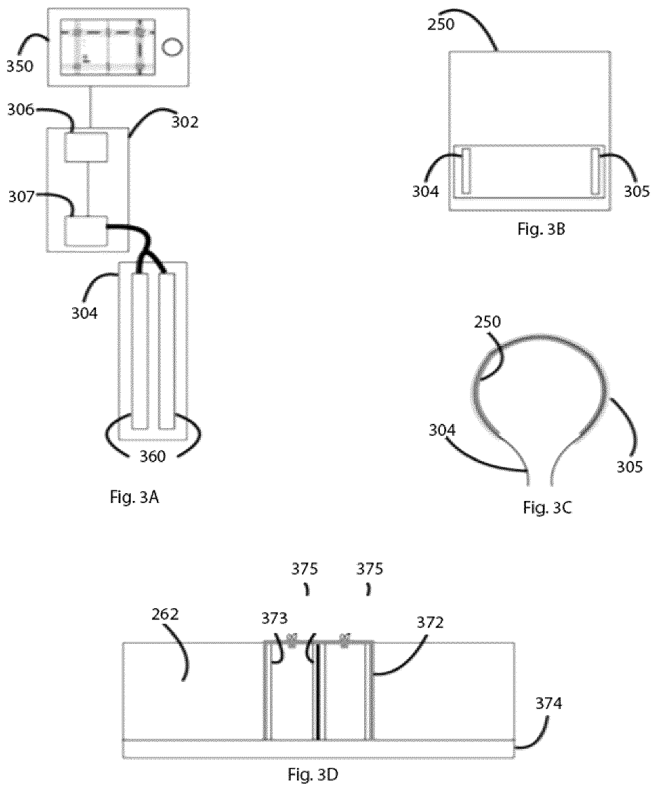

The control system, as shown in FIGS. 3A-D, includes a control unit, detection circuit, and monitoring system. The control unit communicates with various sensors to monitor water levels, vapor density, and environmental conditions. The system can be controlled remotely, allowing business owners to adjust the displayed content and operational parameters in real-time.

The control unit also integrates data from the anemometer to dynamically adjust vapor production and projection parameters based on real-time wind conditions. If the wind speed exceeds a safe operational threshold, the control unit halts vapor production to maintain system stability and safety.

The preferred embodiment includes two flows: the airflow provided by the main fans (Airflow A) and the air/vapor mixture generated in the expansion chamber (Airflow B). The volume of Airflow B does not exceed 6% of the volume of Airflow A, ensuring a stable and visually appealing vapor medium. The system allows for adjustments to the water-to-air ratio, optimizing the display for different environmental conditions.

The vapor barrier device may include additional features such as air curtains or baffles to contain and manage the water vapor volume, ensuring a stable projection surface. The system incorporates sensors to continuously monitor and adjust for changes in wind speed, humidity, and temperature, maintaining optimal performance.

The design of the vapor barriers is suitable for installation in various environments, including outdoor settings with semi-improved surfaces. The barriers can accommodate gradual elevational changes and uneven pavements, ensuring a stable and continuous display.

The vapor barrier system offers a significant improvement over traditional inflatable decorations by providing a stable, engaging, and modern solution for attracting attention to retail storefronts. The use of water vapor and projection technology ensures that businesses can effectively capture the interest of passersby, even in challenging weather conditions.

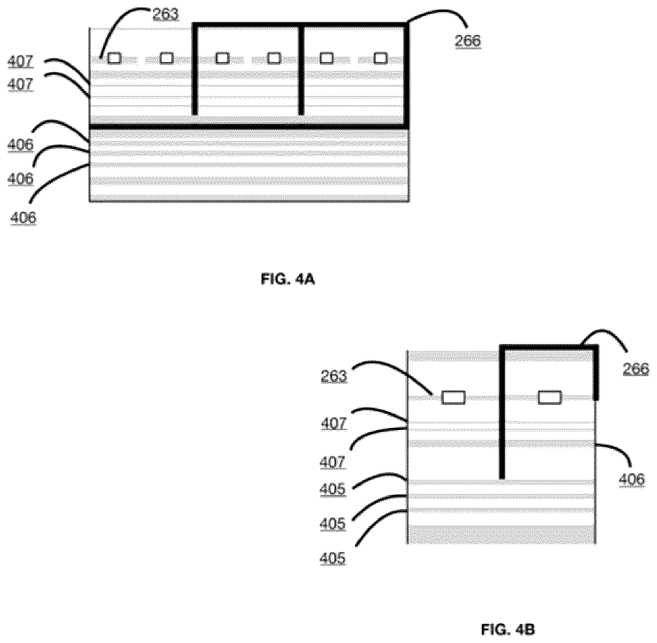

Referring to FIGS. 4A-D, these figures illustrate the detailed construction and functionality of the airbox and nozzle system integral to the display stand. The airbox 264 is comprised of an enclosure that houses the airbox internals, including a series of mesh 407 and honeycomb layers 406, 405. In the preferred embodiment, there are four layers, though the number of layers can vary. The airbox 264 also contains airbox fans 263, which push air through the layers of mesh and honeycomb, creating a laminar airflow that carries the vapor display medium through the air with minimal turbulence.

The nozzle system, as illustrated in FIGS. 4A-D, is comprised of a single nozzle opening from which the sheet of vapor is emitted. The main nozzle tube directs the vapor, generated in the expansion chamber, into the airbox. A drain is included to allow condensation buildup to drain back into the water tank, ensuring the system remains efficient and operational.

The airbox design, shown in FIGS. 4A and 4B, features an optimized structure to manage air and vapor flows. Before entering the airbox, air passes through a honeycomb sheet 405 that acts as an air vane, evening out incoming air turbulence. This helps ensure uniform air pressure as it passes through subsequent layers of honeycomb and mesh screens 407. The arrangement of these components is crucial for maintaining the laminar flow of air and vapor, which is essential for the stability and clarity of the projected images.

The fan assembly within the airbox pressurizes the system, emitting air through a series of honeycomb panels and mesh sheets. Once the air has passed through the airbox, it is free from turbulence and maintains an even pressure, creating a laminar flow of air. This laminar flow is critical for guiding the vapor medium emitted from the nozzle, forming a stable, flat sheet of vapor.

Each side of the airflow created by the airbox fans (Airflow A) surrounds the central air/vapor mixture (Airflow B) generated in the expansion chamber. The design ensures that the vapor will only make up a maximum of 6% of the total airflow volume of the display. This balance is adjustable, allowing the system to optimize the water-to-air ratio depending on environmental conditions and the desired visual effect.

The system can be powered by voltage ranging from 80-260 V, with water as the only additional supply needed. The device is activated by connecting it to a power source via the power supply unit, then turning on the power switch. The system begins by pulling water from the water tank into the expansion chamber, where it is vaporized and pressurized before being emitted through the nozzle.

The vapor barrier device includes an electronic control system, as shown in FIG. 3A, that monitors and controls the water level within the expansion chamber using detection sensors 304, 305. These sensors track changes in water level, ensuring the optimal amount of water is maintained for continuous vapor production.

Referring to FIGS. 4C and 4D, the airbox 264 further includes additional layers of honeycomb and mesh to manage the airflow and ensure the stability of the vapor medium. The honeycomb layers 406, 405 are designed to reduce air turbulence and create a laminar flow, essential for a clear and stable holographic projection.

In one aspect, a method includes loading a plurality of display stands onto a plurality of trailers, directly or indirectly coupling the plurality of trailers to a plurality of delivery vehicles, transporting the plurality of delivery vehicles to a retail location, and unloading the plurality of display stands from the plurality of trailers and placing them in front of stores or curbside to form a vapor barrier.

In another aspect, a method includes attaching detachable axles and detachable couplings to a plurality of display stands, directly or indirectly coupling the plurality of display stands to a plurality of delivery vehicles using the detachable couplings, transporting the plurality of delivery vehicles to a retail location, detaching the detachable axles and the detachable couplings, placing the plurality of display stands in front of stores or curbside to form a vapor barrier, and transporting the detached detachable axles and couplings away from the retail location.

Each display stand may have a projection face, a public-facing face opposite the projection face, a first face between the projection face and the public-facing face, a second face between the projection face and the public-facing face and opposite the first face, a bottom directly or indirectly coupled to the projection face, the public-facing face, the first face, and the second face, a first overlapping structure extending from the first face and adjacent to and set back from the public-facing face by a first amount, and a second overlapping structure extending from the second face and adjacent to and set back from the public-facing face by a second amount. Placing the display stands in front of stores or curbside to form a vapor barrier may include directly or indirectly coupling the first overlapping structure extending from the first face of a first of the plurality of display stands to the second overlapping structure extending from the second face of a second display stand adjacent to the first display stand so that a gap between the first display stand and the second display stand is closed even if a bottom of the first display stand is not aligned with a bottom of the second display stand.

The device can be powered by voltage ranging from 80-260 V. The only other supply needed to run the device is water. To power on the device, one must first plug it into a power source via the power supply unit power plug input 265, which plug may also house a fuse. You then turn the device on by flipping the power switch, which is part of the power plug input housing. Once the device is on, the device will begin to start up by first pulling water from the water tank via the expansion chamber into the intake pump 267. The water is pulled from a water tank and into the expansion chamber via the water inlet port. Water will continue to fill the expansion chamber until the water lifts the float switch to the open circuit position, thus cutting voltage to the pump 267, and shutting off the flow of water. At this time, the emitter will have the optimal level of water above it to create the vapor medium. The expansion chamber is pressurized in the preferred embodiment by two blower fans 268 but in some cases can use more or fewer blower fans, which causes the vapor to exhaust through the vapor output and into the nozzle 262 of the airbox (FIGS. 4A-B). In the event the expansion chamber needs to be drained of water for transportation or storage, water can be drained via the expansion chamber drain valve via the water drainage pump which is controlled by the water drain switch.

Vapor enters the airbox (FIGS. 4A-B) via the nozzle 262. Due to the pressure that is applied to the vapor, the vapor then exhausts from the nozzle 262 through four layers of honeycomb, three of which are ½ inch in thickness 406 and the final layer may be 2 inch in thickness 405, though fewer layers or more layers may be used and their thickness could vary between ⅛ inch and 8 inches. After the final layer of honeycomb 405, the vapor then exits the airbox (FIGS. 4A-B). As vapor collects within the nozzle 262, condensation is bound to occur. The resulting water may drip through the honeycomb and out, which can be left to fall to whatever surface is below, or into a receiving trough.

The vapor medium exhausted by the nozzle 262 is supported by layers of air pressure on both sides; these are supplied by the airbox fans 263. The airflow from the airbox fans 263 first passes through sheets of mesh screen 407 to even out air turbulence and pressure, the airflow then passes through a series of honeycomb sheets 406 that are evenly spaced apart. After the first series of honeycomb sheets, the airflow and vapor pass through a final layer of honeycomb 405 and more or less depending on the embodiment. These layers of honeycomb even out turbulence and pressure from the airflow, resulting in a laminar flow of air that acts as barriers guiding the vapor medium that is exhausted from the nozzle 262 in a flat and straight form. The nozzle 262 receives vapor from the ultrasonic expansion chamber via the vapor output tube 266. Before the airbox fans 263, there is a layer of honeycomb 405 that acts as air vanes, controlling incoming air turbulence and allowing for a more uniform fan output. Directly after the airbox fans, there is another sheet of honeycomb 405 that reduces air turbulence and evens air pressure before the airflow reaches the layers of mesh 407.

Before the air enters the airbox (FIGS. 4A-B), air passes through a sheet of honeycomb 405 which acts as an air vane. This helps to even the incoming air and allows a more uniform exhaust into the second layer of honeycomb 405 found directly after the airbox fans 263. The second layer of honeycomb 405 takes the pressurized air and begins evening out the pressure and turbulence before the air gets to the series of mesh screens 407. The airbox contains a series of honeycomb panels and mesh sheets that break up the turbulence and even the air pressure of the air supplied by the fan assembly, creating a laminar flow of air on both sides of the nozzle. The nozzle located centrally in the airbox deposits a steady, even stream of vapor through the series of honeycomb panels and mesh sheets independent of the airflow being supplied by the fan assembly. When the vapor medium passes through these layers, its turbulence is also reduced and pressure is evened out, thereby creating a laminar flow of vapor between the laminar flow of air creating a sheet of vapor on which light can be projected upon by a light source.

The fan assembly pressurizes the airbox and emits air once passing through a series of honeycomb panels and mesh sheets. Once the air has passed through the airbox, it is free from turbulence and at an even pressure, creating a laminar flow of air, which maintains its trajectory in the direction it is being emitted. The honeycomb, referred to in each embodiment, can have cells of various shapes and sizes. These shapes include hexagonal, cylindrical, square, rectangular, pentagonal, octagonal, and so on. In the preferred embodiments, a hexagonal or cylindrical cell-shaped honeycomb may be used. The cell sizes and lengths may also vary depending on the embodiment. In the preferred embodiment, sizes of honeycomb cells are ¼ inch for both hexagonal and cylindrical cell shapes. In the preferred embodiment, ⅝ inch and 2 inch depth cells are used, though cell depth as well as cell size can vary in alternative embodiments.

The preferred honeycomb cell size is ¼ inch. In some embodiments, larger sizes may offer increased protection from condensation as the size of the cell is larger (which makes it more difficult for water to collect). However, the display quality diminishes, resulting in some visible separation lines from the discrete cells. The displays in some embodiments may use ½ inch cells. For example, a smaller cell size will have a fuller body of vapor barrier and less noticeable lines, but it will accumulate condensation much faster than a larger cell, which requires outside interaction to clear. A ½ inch cell size would also work nicely in terms of very little risk of condensation as the cell walls are too far away from each other to easily allow a water droplet to collect the whole way around before dripping out. However, the vapor barrier quality is degraded, much less full-bodied with more visible lines. When selecting a cell width, the inventor discovered an optimal balance of quality and low condensation obtained by ¼ inch cell size.

The honeycomb, referred to in each embodiment, can be made of various materials. Honeycomb materials of aluminum in various grades or plastic (thermoplastics, polycarbonate, ABS, PVC, polypropylene, and other plastic compositions) are used. Though in alternative embodiments, a honeycomb material of Kevlar, carbon, aramid, cardboard, varieties of steel, and other metals or fibrous materials may be used. The most important nozzle specification is the slot width of the mouth, which is consistent across all devices. In the preferred embodiment, the width is measured at ¼ inch. This corresponds in the preferred embodiment to a ¼ inch honeycomb cell to avoid condensation and clogging within the cell. Using a thicker barrier uses more water. The water droplet size ranges between 15 to 18 microns. The droplets are created using an ultrasonic transducer. The small liquid droplets are suspended in a flow of air, and the vapor makes up less than 6% of the flow's volume. The vapor medium is emitted from the nozzle located within the airbox. The light source emits light upon the vapor medium, which reflects and refracts said light, creating a vapor barrier on the vapor medium.

The device in various embodiments creates laminar flows using a series of fans to pressurize one end, the airflow through the series of honeycomb, tubular, mesh layers, and empty spaces. Upon this air reaching the single nozzle, the pressure and laminar flow of the medium then pull the low-density vapor medium through the remaining honeycomb, tubular, and mesh layers and out of the airbox in the form of a flat sheet of low-density vapor and primarily air.

In the preferred embodiment, there are two flows present in this display technology: the airflow provided by the main fans (Airflow A), and the flow of the air/vapor mixture being generated in the expansion chamber (Airflow B). The volume of air/vapor mixture in B will not exceed 6% of the volume A (carrier air), but B itself is not 100% vapor. The air/vapor mixture in B is less than 1 part water to 100 parts air. Thus, the output air/vapor mixture of the barrier is less than 5 parts water to 10,000 parts air. One can adjust the airflow of the main fans A and the expansion chamber blower fans and thereby adjust the ratio of water to air. Slightly increasing the ratio of water to air (i.e., water density) may be useful in bright ambient light environments to increase the apparent brightness of the vapor barrier.

The two airflows are labelled as A and B. Airflow A is the airflow that is created from the rear fan assembly of the airbox; it travels through the airbox past the nozzle, through multiple layers of honeycomb and mesh, and out of the front split on either side of Airflow B. Airflow B is the air/vapor mix that is created inside of the chamber, pressurized by the blower fan, and emitted through the nozzle, through multiple layers of honeycomb, and then out of the airbox between the split airflow layers of Airflow A. Each side of Airflow A will never be thinner than 2 inches as it is a physical limitation on the airbox's internal nozzle design. Generally, the larger the area, the thicker the Airflow A. An area that is emitted 15 inches from the honeycomb would have 4 inch thick sheets of air on either side provided from the single airflow A. It is found that every time you double the emission distance, you increase the width by 0.75; for example, to have an area emitted 15 inches would take 4 inch sheets of air on either side of flow B, for an area emitted 30 inches, it would take 7-inch air sheets on either side of flow B. For an area emitted 60 inches, it would take a sheet of airflow thickness of about 12.5 inches on either side of flow B.

The vapor will only ever make up a maximum of 6% of the total airflow volume of the display. The display may operate, however, with the vapor making up as little as 2% of the total air flow volume. Where the density falls within that range is up to the user and is changed depending on different environmental variables such as light, ambient humidity, ambient airflow, content, as well as the desired effect of the user. This percentage is controlled via voltage variation of the power supply, as well as the variable voltage of the blower fan power supply via set screw.

By integrating advanced water vapor and projection technology, the invention provides a significant improvement over traditional methods, ensuring a visually engaging, stable, and modern solution for retail storefronts. The inclusion of an anemometer to detect windy conditions and halt vapor production ensures enhanced safety and stability, making the system robust against adverse weather conditions.

1. A business attraction device for generating c in front of stores or curbsides, the device comprising:
a water tank for holding water;
a detector strip extended along a length of the water tank;
a detection circuit in electrical communication with the detector strip;
a control unit in electrical communication with the detection circuit;
an airbox for creating a laminar flow of air and vapor;
a power supply unit;
a display stand having a projection face and a public-facing side, with a first face between the projection face and the public-facing side, a second face between the projection face and the public-facing side and opposite the first face, a partition between the projection face and the public-facing side, and a bottom coupled to the projection face, the public-facing side, the first face, and the second face;
an expansion chamber for creating vapor;
a nozzle having a single nozzle opening for emitting a sheet of vapor;
a projector integrated with specialized lenses and optics for projecting 3D imagery onto the water vapor medium;
environmental sensors and control systems for dynamic adjustment of vapor generation and projection parameters; and
a comprehensive environmental monitoring system that includes an anemometer to detect windy conditions and provides continuous feedback to the control unit, enabling real-time optimization of the 3D projection system, and stops vapor production when excessive wind conditions are detected.

2. The device of claim 1, wherein the projector utilizes light field rendering, volumetric displays, or computational holography to generate the 3D holographic effect on the water vapor medium and is capable of projecting high-resolution 3D images with minimal latency and high brightness, providing an immersive visual experience.

3. The device of claim 1, further comprising air curtains, baffles, or specialized chambers to contain and manage the water vapor volume, ensuring a stable projection surface, and incorporating predictive modeling and adaptive control algorithms to anticipate and compensate for environmental changes, ensuring a high-quality, stable holographic display.

4. The device of claim 1, wherein the control unit dynamically adjusts the vapor production and projection parameters based on real-time sensor data, maintaining optimal performance under varying environmental conditions, and stops vapor production when excessive wind conditions are detected by the anemometer, with the water vapor medium maintained at a uniform density and distribution through precise control of vapor generation and air flow.

5. The device of claim 1, further comprising humidity sensors and air flow monitors to continuously assess and adjust the environmental conditions around the vapor projection area and includes laminar flow chambers to stabilize the water vapor and create a uniform projection surface.

6. The device of claim 1, wherein the vapor containment system includes multiple layers of honeycomb and mesh screens to reduce air turbulence and create a stable, laminar flow of air and vapor, and wherein the nozzle width is approximately ¼ inch.

7. The device of claim 1, wherein the honeycomb panels comprise hexagonal cells having ¼ inch size, and the vapor consists of water droplets having mean diameters in the range from 15 microns to 18 microns, with the laminar flow of air and vapor comprising between 2% and 6% water vapor.

8. The device of claim 1, further comprising a monitoring system in electrical communication with the control unit, wherein the control unit is capable of causing the monitoring system to report information derived from the changes in water level to a command officer, and wherein the control unit determines that the water tank is in a nonfunctional state when the water level switch in the water tank is in a first state.

9. The device of claim 1, further comprising fittings whereby the display stand can be lifted by a trolley and placed by the trolley into a desired location, and wherein the water tank is connected to the expansion chamber housed in the first compartment, a secondary water input from the nozzle drain, a water-tight container, a water inlet port, a water drain port, and water level indicator.

10. The device of claim 1, wherein the control unit uses an electronic reading from the detection circuit to determine the water level of the water container when the water level switch determines that the water tank is in a nonfunctional state, and wherein the system can be powered by voltage ranging from 80-260 V, with water as the only additional supply needed.
